(19) United States
(12) Patent Application Publication
(10) Pub. No.: US 2002/0070863 A1
(43) Pub. Date: Jun. 13, 2002

(54) Tagging system and method

(76) Inventor: Timothy John Brooking, East Sussex (GB)

Correspondence Address: SCHWEGMAN, LUNDBERG, WOESSNER & KLUTH, P.A., P.O. BOX 2938, MINNEAPOLIS, MN, 55402, US

(21) Appl. No.: 09/978,652

(22) Filed: Oct. 16, 2001

Related U.S. Application Data
(63) Continuation of application No. PCT/GB00/00992, filed on Mar. 16, 2000.

(30) Foreign Application Priority Data
Mar. 16, 1999 (GB) 9906037.8

(51) Int. Cl. G08B 13/14

(52) U.S. Cl. 340/572.1

(57) ABSTRACT

A tagging system for persons or objects comprises tags to be carried by the person or object, each tag transmitting a signal carrying a unique identification code and preferably including a smart card for the purchase of goods and services. A first type of tag detector is arranged at entrances to areas and detects signals from tags passing through the entrances. The detection region of this type of tag detector is limited to the region of the entrances. A database holds information from the respective persons or objects and the unique identification code of the tags being carried by the persons or objects and it receives and stores information on the use of the areas by the person. An entrance processor processes the detected signals to generate an invalid tag signal if a received unique identification code is invalid. A second type of tag detectors is provided for detecting signals from tags in the areas. The detection range of the second type of tag detectors are substantially larger than the detection range of the first type of tag detectors since these are provided for safety reasons or to provide a search and rescue capability. Card readers can be provided at outlets for goods and services in the resort and transactions are recorded in the database to provide further resort management information on spending habits.

### RELATED APPLICATIONS

This application is a continuation under 35 USC 111(a) of PCT/GB00/00992 filed Mar. 16, 2000 (WO 00155818), which claimed priority from British application Serial No. 99/06037.8, filed Mar. 16, 1999, which applications are incorporated by reference.

### FIELD OF THE INVENTION

The present invention generally relates to a system and method for tagging persons such as skiers, mountaineers or hikers or objects such as boats, cars and airplanes. In particular, one aspect of the present invention relates to an apparatus and method for tagging persons such as skiers, mountaineers or hikers so as to both control access to ski lifts, cable cars etc. giving access to skiing areas or mountains, and to provide a search and rescue capability. The present invention also relates to a resort management system in which a tag stores monetary value information and a processing system links information on persons, locations and monetary value adjustments.

### BACKGROUND OF THE INVENTION

There are in existence methods of enabling search and recovery of personnel lost on mountains or victims of avalanche. Such systems include passive tags sewn into ski wear which may be read by suitable detectors. Such a system is available from RECCO AB. Such a system, however, has a limited range, and it is not known in advance which skiers may have the tagged ski wear.

It is also known to provide for the automatic accessing of ski lifts and the like using identity cards with photos and bar codes, swipe cards and passive short range tags incorporated within a lift pass.

There is however, no prior art system which provides a ski lift access control system integrated with an active personal tag which is effective for search and rescue purposes.

### SUMMARY OF THE INVENTION

One aspect of the present invention provides an integrated tagging system which provides both ski lift, cable car access and inter-resort transport control and a personal safety tagging capability which can operate without requiring a transmission licence from the authorities. This aspect of the present invention is designed to use a tag which transmits a signal. As is known tagging system readers (proximity meters) are required to pick up and interpret signals. In this arrangement a first type of detector is provided for access control to detect tags passing through entrances to ski lifts and the like. This is known technology as is used in situations such as accessing the Dartford Tunnel in the UK. Such a type of detector has a limited detection range to limit the region in which tags are detected to only the entrance region of the ski lift and the like. This provides the ski lift access control capability. Thus a skier must carry a ski lift pass which incorporates the tag in order to gain access to the ski lift.

This aspect of the present invention uses these detectors in an alternative configuration such that they have a much longer range. These may be standard readers as for access control but with range alteration and added antenna configuration considerable reading range is added to the basic reader. These then are provided for security and safety on the skiing areas with the capability of reading the same tag as for accessing the ski lifts. For example, they can be provided in fixed positions in the vicinity of restricted areas to detect persons entering high risk or restricted areas giving resort personnel early warning that skiers may be in danger or in an area that could provoke avalanche risk. Skiers in such areas may be unaware of their position, through adverse weather conditions but specific information on regular offenders, in good conditions and in the knowledge they were illegally “off piste” would be available through the database and necessary action could be taken, such as a stop being put on their lift pass and smart card. Specific knowledge of a skiers whereabouts would reduce search time significantly should he/she be reported lost at anytime since their last recorded reading, be it from a remote or lift reader will be on the database giving time and specific read point geographically. One or more detectors can be used by search and rescue personnel in order to locate skiers, mountaineers or hikers who are lost or incapacitated. Such a type of detector is mobile and can either be hand held or mounted on a vehicle such as a helicopter or snow mobile.

This aspect of the present invention provides the advantage of an integrated access control system and search and rescue system at low cost since the level of the signals is kept below the level at which a license is required from the authorities. The long range detectors are however sensitive enough to detect tags at a range of 200 to 400 meters, depending on the physical nature and terrain in the area of use.

In an embodiment of the present invention, the adaptation of the detector for search and rescue use includes using a directional antenna to enable the location and identity of a person carrying the tag to be determined.

In a preferred embodiment the tag is active and includes a power supply (a battery), a circuit including stored identification code for generating an electromagnetic signal and an antenna for transmitting the signal. Preferably the signal is transmitted as a low frequency radio signal at a level below that which a license is required from the authorities.

In an alternative embodiment, the tag is passive and responds to an activation signal to transmit the signal. In this embodiment, the first and second tag detectors transmit the activation signal and receive the resultant signal from each tag. In this embodiment, preferably the first tag detectors transmit the activation signal only within the region of a respective entrance and the second tag detectors transmit the activation signal over a substantially larger range.

In one embodiment the second tag detectors are substantially more sensitive to signals from the tags than the first tag detectors.

In an embodiment of the present invention, each tag transmits a signal carrying a unique identification code and a database of information on persons and the tags that they are carrying provides an added benefit of being able to not only identify persons if they are unfortunate to have to be located by a search and rescue team, but also it provides useful management information for a ski resort. The usage of the ski lifts and the like can be logged for each user to identify a pattern of activity. This can be used for management and planning purposes.

A second aspect of the present invention provides a resort management system in which tags are issued to persons in the resort. Each tag transmits a unique signal to identify the person carrying it and includes a readable storage means for storing monetary value information. Information on the persons who have been issued with tags is collated in a central processor forming an information database. As the person moves around the resort, tags carried by persons are detected in the vicinity of tag detectors. Tag detections are input to the centralized processor to provide information on the location and movement of persons. When a person wishes to purchase goods or services, or top-up the monetary value of the tag, reading means are provided in the resort to adjust the monetary value information carried by the storage means accordingly. Information on the adjustment of the monetary value information is also input to the central processor. Information on the identity and locations of persons and their spending habits is thus formed in the central processor by linking the data obtained from the issuance and detection of tags and the reading of the storage means on the tags.

Thus when tags are issued to persons using the resort, a great deal of information can be obtained from the person. The tag can be provided to enable the person to gain access to areas of the resort e.g. ski lifts in a ski resort. At the time of issuance of a tag, a person can load the tag with a certain amount of monetary credit to be used for purchases of goods and services throughout the resort. In this way, the tag can be used for gaining access to areas of the resort, and for providing a simple means of purchasing goods and services in the resort.

In a preferred embodiment, the resort management system uses the tagging system of the first aspect of the present invention to integrate a search and rescue system with a resort management system.

A convenient form of the tag comprises a tag body housing a transmitter and memory storing the unique tag identification, and a smart card which is removable from the tag body. The smart card contains the monetary value information in a conventional known manner. Identification codes given to the tag and to the smart card can be linked in the central processor for the resort in order to link information on the location and identity of persons and purchases made.

### BRIEF DESCRIPTION OF THE DRAWINGS

Embodiments of the present invention will now be described with reference to the accompanying drawings; in which:

FIG. 1 is a schematic drawing of the implementation of a tagging system in a ski resort,

FIG. 2a is a schematic diagram of one side of a tag;

FIG. 2b is a schematic diagram of the other side of the tag;

FIG. 3 is a schematic diagram of a tag detector to be provided in the skiing areas;

FIG. 4 is a schematic diagram of a tag detector to be provided at the ski lift entrances; and

FIG. 5 is a schematic diagram of a tag detector to be used by search and rescue personnel.

### DETAILED DESCRIPTION

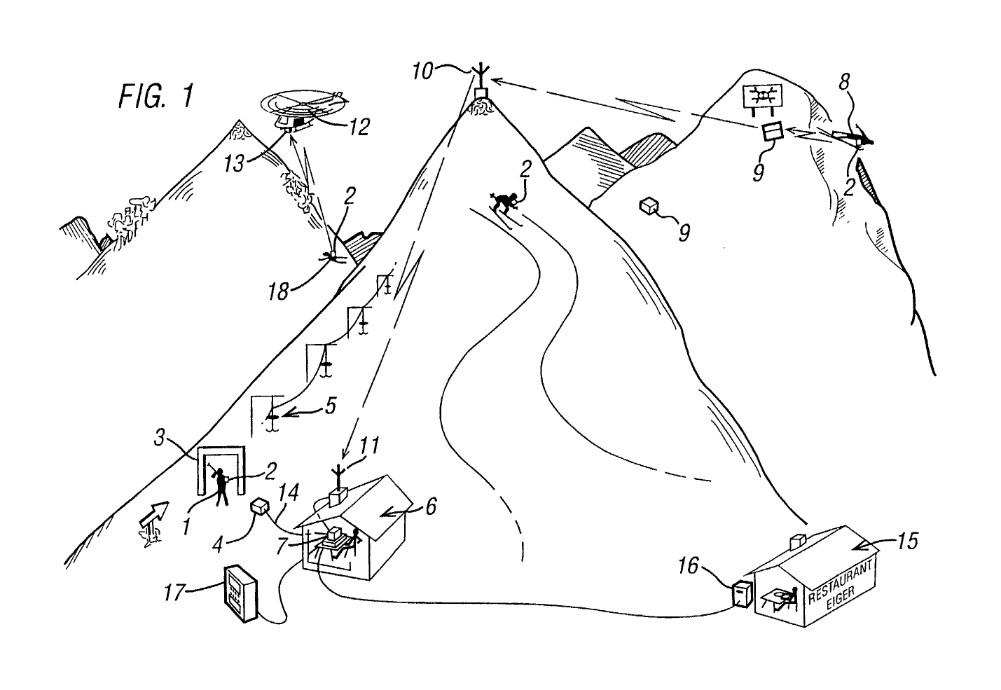

Referring to FIG. 1, the implementation of a tagging system in a ski resort is illustrated. When a skier wishes to use the ski lifts in order to gain access to the skiing areas, they will be required to purchase a ski pass. The ski pass incorporates the tag and thus when the ski pass is purchased, a tag unique identification number is recorded for the skier together with personal information such as their name, address, contact numbers, place of residence, whether full time or local such as the local chalet, hotel, flat etc. This information can be entered into a database for management purposes.

As can be seen in FIG. 1, when a skier 1 wishes to access the skiing areas, they will necessarily have to carry a ski pass 2 carried about their person. This can be obtained from a kiosk 17 comprising an automatic vending machine. A person enters the required information e.g. name, address etc and enters their credit card details to be issued with a tag and smart card combined. The entered information is transmitted to a central control station 6 to form and store a database.

As the persons pass through the entrance 3 of the ski lift 5 they pass by tag detectors 4 which are of a first type which have a limited range of detection; the range of detection being limited to the entrance region 3 of the ski lift 5. Thus, skiers 1 using the ski lift can be detected and logged. The tag detectors 4 are linked via a communication line 14 to a central control station 6. Within the central control station 6 a computer 7 stores a database of information on the tags and skiers and will thus store ski lift usage information for each skier.

The tag detector 4 can either include some local processing capability or can refer back to the computer 7 in the central control station 6 in order to perform access control. When the unique identification code of the tag is detected, it is compared with valid codes to determine whether access should be allowed or denied to the skier 1. Thus for example, if the tag has been reported as being stolen, the validity of the identification code would have been cancelled and thus a skier attempting to use the stolen tag (ski pass) will be denied access to the ski lift. Also, since the ski passes may only be valid for a particular period of time e.g. for the one week stay by the guests at the resort, any attempt to use the ski pass outside this period of validity will result in access to the ski lift being denied.

All of the information to control access to the ski lift can be stored within the computer 7 within the central control station 6.

The tag detector 4 at the entrance 3 to the ski lift 5 is able not just to detect the skiers 1 individually as they pass the entrance but can detect multiple skiers and perform access control rapidly.

Although in this embodiment a signal line 14 is 20 provided between the tag detector 4 and the computer 7, a radio frequency link could be provided instead as illustrated in the embodiment of FIG. 9 to the control center 6.

The tag can also be used for controlling the use of 25 buses to and from the ski lift i.e. it acts as a ticket. In such an arrangement tag detectors such as the tag detectors 4 can be used with an antenna to communicate with the central control station 6. The tags can thus be used to detect skiers going to and from the ski lift.

This feature of the embodiment of the present invention thus provides for not only access control to the ski lift and buses but also a monitoring function to allow for the behavior of skiers to be monitored. This can be used f or planning and management purposes.

Within the resort, there are also provided restaurants and the like to allow persons to buy goods or services. The smart card issued to each person can be used for this purpose. Each smart card is loaded with a certain amount of credit when issued and this can be topped-up when necessary by for example using the kiosk 17. Thus as shown in FIG. 1, at a restaurant 15 there is provided a smart card reader 16 for reading the smart card carried by the tag. The appropriate cost of a meal can be deducted from the value carried by the smart card and this information on the transaction can be transmitted to the central control station 6. Thus, in this way the computer 7 in the central control station 6 receives not only information on the person received during issuance of the tag and the location information obtained from the tag, but also information on the spending habits of the person. This information can be extremely useful to resort managers for planning and management purposes. The provision of a smart card associated with a tag has the benefit of eliminating the need for separate cash or credit cards in the resort. The smart card and the tag are designed to provide everything a skier should need around the resort by providing access control and means of purchase. From the resort managers point of view, the combined smart card and tag provides the benefit of safety in that locations of skiers can be determined, and security since both the card and tag are linked at the point of issue by associating their unique identification numbers. This protects again fraud in the event of loss.

At the end of the required use of the card and tag, they can be returned to the machine where a refund on a deposit paid for the tag can be returned together with any remaining credit on the smart card. The tags and cards can then be recycled for further use.

In the skiing areas, a second type of tag detector 9 can be provided at the boundary of or in a vicinity of regions which the ski resort managers do not wish skiers to access e.g. Of f piste areas, avalanche risk areas, or areas that are simply restricted. The tag detectors 9 have a much greater range than the first type of tag detectors 4 and can be omnidirectional or directional in their detection of tags 2 provided on skiers 8 which enter the restricted areas. Because of the remoteness of the tag detectors 9, it is usually impractical to provide for land lines to the central control station 6. Thus the tag detectors 9 are provided with radio frequency transmitters. The transmitters can either have the power to transmit directly to an antenna 11 provided at the central control station 6, or can be low powered transmitters which are detected by a local antenna 10 which can amplify and relay the signals to the antenna 11 of the central control center 6.

In this way the central control station 6 is able to monitor and identify skiers who enter restricted areas. This information can simply be used to warn the skier 8 when they descend that should they violate the restricted area again, sanctions will be taken against them. Alternatively, the violation of the restricted area by the skier 8 could result in the resort managers deciding to take action and intercept the skier. The system provides the information which can allow the resort manager to decide how to act. This information can also be used for giving an indication of the possible location of a skier if they are reported missing. An indication that a skier has passed by certain tag detectors 9 would give an indication of the possible locality of the skier 8. Of course, the skier may simply have passed by the tag detectors 9 and may have descended from the mountains by some other route.

If a skier 18 is reported missing, it is possible for search and rescue team to use the tag 2 to be worn by the skier 18 to locate the skier. For example, the search and rescue team can use a helicopter 12 provided with a tag detector 13 of a second type which has a long range capability in order to locate the skier 18. The tag detector 13 provided in the helicopter 12 has a directional antenna to allow an operator to guide the helicopter 12 in the direction of any signal detected from the tag 2 worn by the skier 18. The tag detector 13 is even able to detect the skier 18 even when buried under snow due for example to an avalanche. The detector range of the tag detector 13 is anything from 150 to 400 meters. It can be joystick operated over a sweep angle by an operator within the helicopter 12 in order to control both the attitude and azimuth of the antenna.

Thus the feature of the provision of the long range tag detectors 9 and 13 in this embodiment provides for a safety and security feature within the tagging system and provides a rapid location method for avalanche victims.

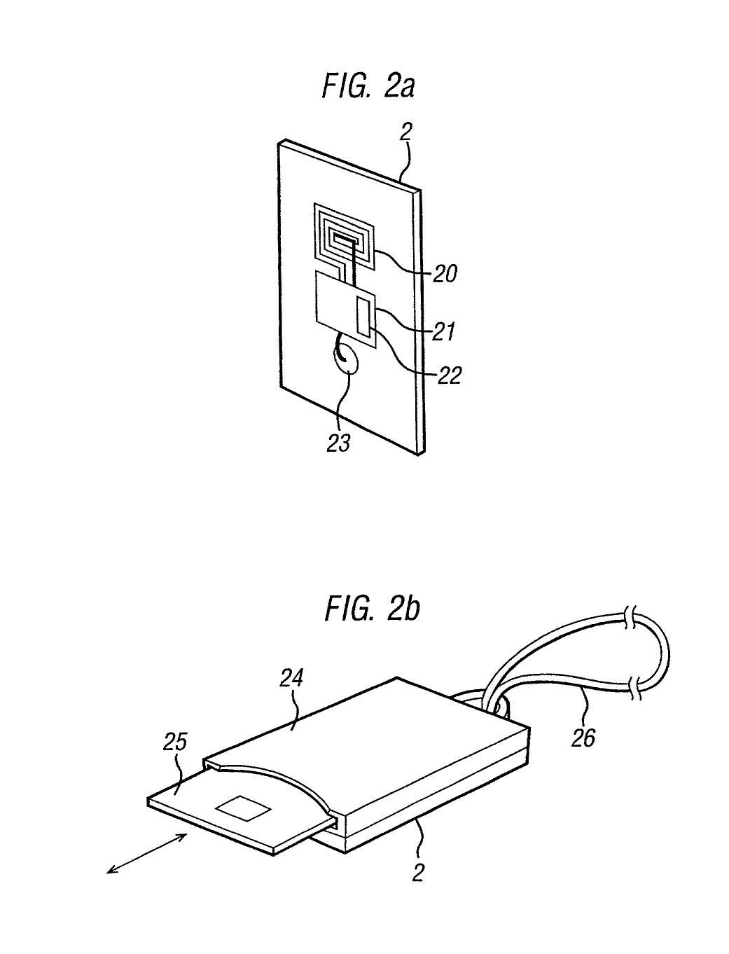

FIGS. 2a and 2b are schematic diagrams of a tag for use in the system. The tag comprises a ski pass in a tag part 2 and incorporates within the ski pass an antenna 20, and an electronic circuit 21 connected to the antenna 20 which incorporates a component 22 storing the unique identification code for the tag. The circuit is powered by a small battery 23. Thus the tag is an active tag which, in order to save battery life periodically such as once every second, transmits a signal at 433.92 MHz and at an output power of 10 mW carrying the unique identification code read from the component 22. The power of the transmitted signal is below the level at which a license is required. Such tags are commercially available from Advanced Technology Communications Limited for example. The tag can also incorporate an anti-tamper device and a low battery warning device. On one side of the tag part 2 is a smart card holder 24 into which a smart card 25 can be inserted. The tag assembly is also provided with a cord 26 to allow the tag assembly to be hung around a skier's neck. When the smart card 25 is to be used for payment of goods or services, or recharged with monetary credit, it can be removed from the holder 24 and placed in a card reader.

In this embodiment of the present invention a single 25 (the same) tag is used to provide both access control and a search and rescue capability. It is the detectors for the two capabilities which are different.

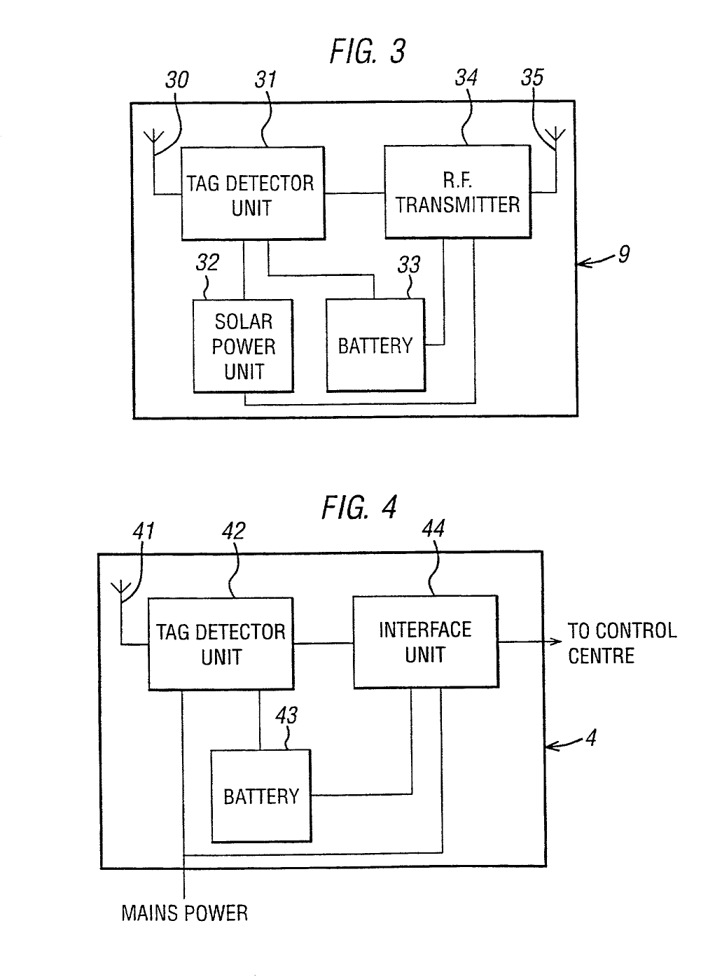

FIG. 3 is an illustration of the second type of tag detector 9 provided in the vicinity of restricted areas. The detector 9 includes an antenna 30 for detecting the signals from the tags. The antenna is connected to a tag detector unit 31 for analyzing the signal in order to extract the unique identification code. The unique identification code extracted is then passed to a radio frequency (RF) transmitter 34 which includes an antenna 35 in order to transmit a signal identifying the received unique identification codes either directly to the antenna 11 of the control center 6, or to the local antenna 10 for retransmission to the antenna 11 of the control center 6. The tag detector 9 is powered either by a solar power unit 32 or by a battery 33. The battery 33 is provided for backup when there is not enough output from the solar power unit 32 to power the tag detector 9. Thus this tag detector 9 does not require either mains power or a direct physical connection with the control center 6 enabling the positioning of these devices in remote areas.

FIG. 4 is a schematic diagram of a tag detector 4 provided at the entrance 3 to the ski lift 5. Such a detector is for example available from Advanced Technology Communications Limited. The tag detector 4 is provided with an antenna 41 connected to a tag detector unit 42 to analyze signals received from the tags in order to extract the unique identification code. This is then passed onto an interface unit 44 which generates a signal for output to the central monitoring station 6. The tag detector 4 is powered by external mains power and is also provided with a battery backup 43. Thus, because the tag unit 4 is provided usually in accessible areas, it is provided with mains power and a direct physical connection to the central monitoring station 6. However, where such facilities are difficult to provide, a unit similar to the tag detector 9 can be provided.

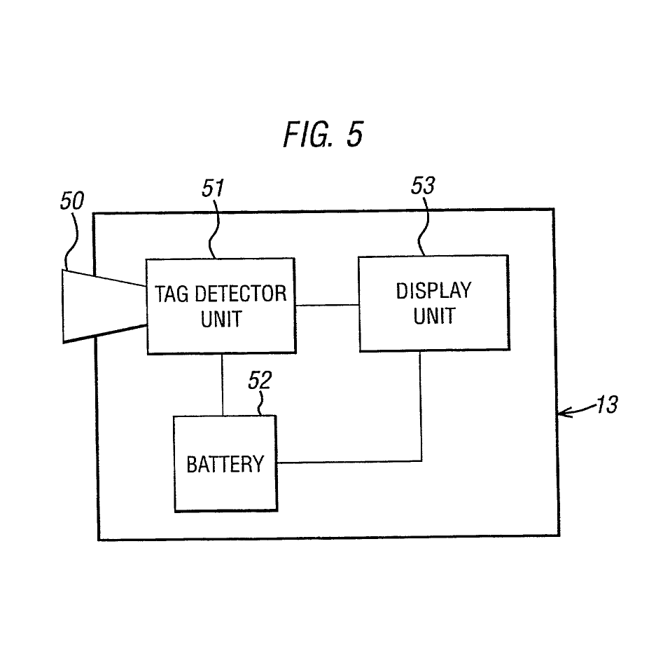

FIG. 5 is a schematic diagram of a mobile tag 15 detector 13 for use by the search and rescue personnel. The tag detector 13 is provided with a directional antenna 50. The antenna 50 can be steerable when the tag detector 13 is provided on a vehicle such as a helicopter. Alternatively, if the tag detector 13 is portable, the antenna 50 can be fixed to allow an operator simply to move the whole device in order to determine the directionality of the received signal i.e. the tag 2. The signals detected by the antenna 50 are analyzed by a tag detector unit 51 in order to extract the unique identification code and signal. This code is then output to a display unit 53 to display the identification code to an operator. The tag detector 13 is powered by a battery 52.

In this unit the mere display of the identification 5 code for a located tag is sufficient since it enables the search and rescue personnel to contact the control center 6 in order to identify the wearer of the tag. This enables the search and rescue personnel to check whether they have located the person who was reported missing. They may actually have located some one who was not reported missing but who nevertheless needs to be rescued. They would thus need to resume the search for the person who was reported missing.

The tag detectors 9 and 13 are more sensitive than 15 the tag detector 4 and thus have a much greater range enabling their use in the detection of tags in the skiing areas.

As can be understood from the description of the embodiment of the present invention, one aspect of the present invention provides for a complete ski resort management system which is capable of controlling access to ski lifts, monitoring access to danger areas such as closed runs, off piste areas, avalanche danger areas etc., and enabling an efficient search and rescue operation when skiers are reported missing. This is facilitated by the use of the tag detection system having a limited range for use as a ski lift access control system and of a much greater range for use as a search and rescue system. The preferred system provided is inexpensive since it uses signals which are of low power and below the threshold at which licenses are required from the authorities.

Although in the specific embodiment described with reference to the drawings, the tag is an active tag having a battery, the present invention is equally applicable to a passive tag wherein the tag detectors are further equipped with a circuit for generating an activation signal which is transmitted to a region in which the tag is to be detected. For the tag detectors 4 for access control, the range of transmission of the activation signal can be restricted to the region around the entrance 3. For the tag detectors 9 and 13, the range of the activation signal is much greater in order to provide a greater tag detection range. When the passive tag of this alternative embodiment detects the activation signal, it retransmits or reflects the signal modified by the unique identification code of the tag. This retransmitted or reflected signal can then be detected by the tag detectors.

Although the embodiments have been described with reference to skiers, the present invention is applicable to any activity where there is a need to control access and to be able to locate persons in an emergency in an area such as on mountains, theme parks and game parks (wild life reserves).

The tag could incorporate both passive and active chips where the two different types of readers detect either the passive or active port of the tag.

The application of relatively inexpensive tags to a long range reading capability utilizing helicopter search techniques may be used for search and rescue operations for walkers such as individuals or groups lost on mountains. Although not specifically known by name or number, the aid to their recovery will be greatly enhanced with possible life saving consequences and reduction to the risk of hyperthermia.

Although the embodiments of the present invention have been described with reference to a system for tagging persons in a resort, the present invention is applicable to the tagging of persons for whatever reason to detect the movement of the persons out of desired regions into undesired regions. For example, the tagging system can be used for tagging prisoners who are released into the community with restrictions on their movements. The tags can be used to monitor the movements and warn of violations of the prisoner's parole.

Also, the present invention is applicable to the tagging of passengers in an airport by way of tagging the boarding cards. Currently, one of the major problems in airport management is keeping track of passengers who are waiting to board an airplane. Passengers who leave desired regions into undesired regions, e.g. leave the terminal building, can be detected in order to warn the airport managers.

The personal tagging system is also applicable to search and rescue teams and firemen when carrying out their duties. Once the personnel leave the desired areas and therefore enter restricted territory, these movements can be detected and a warning provided. Thereafter, the long range tagging system can be used to trace the personnel.

Although the embodiments of the present invention described hereinabove have been described with reference to a tagging of persons, the present invention is not restricted to this, but is also applicable to the tagging of objects such as boats, cars, airplanes and containers. For example, in a marina application, boats can be tagged and when the boat is in the marina, this can be detected using a low range detector. When a boat leaves the marina without authority, a long range detection system can be used for detecting the location of the boat using the tag. A similar system can be used for detecting the unauthorized movements of cars, airplanes and containers.

Although the present invention has been described hereinabove with reference to specific embodiments, it will be apparent to a skilled person in the art that modifications can be made without departing from the spirit and scope of the invention.

1. A tagging system for persons or objects, the tagging system comprising:
tags to be carried by the persons or objects, each tag being adapted to transmit a signal carrying an identification code unique to the tag;
at least one first tag detector for arrangement at one or more entrances to areas, and for detecting the identification code carried by the signals from tags passing through the or each respective entrance, the detection region of said at least one first tag detectors being limited to the region of a respective said entrance;
entrance processing means for processing the detected identification codes to generate an invalid tag signal if a received signal is invalid;
at least one second tag detector for detecting the identification code carried by the signal from tags in the areas, the detection range of said at least one second tag detector being substantially larger than said at least one first tag detector; and
database means for holding informnation on respective persons or objects and said codes for tags being carried by respective persons or objects, and for identifying respective persons or objects using identification codes detected by said first and second detectors.

2. A tagging system according to claim 1, wherein said at least one second tag detector includes at least one said second tag detector which is mobile for use for locating lost or incapacitated persons or objects.

3. A tagging system according to claim 1, wherein said at least one second tag detector includes at least one said second tag detector for arrangement in the vicinity of one or more areas restricted for persons or objects; the system including monitoring means for monitoring detections by said at least one second tag detector to warn of any persons or objects in the vicinity of the or each restricted area.

4. A tagging system according to claim 3, wherein each of said at least one second tag detector for arrangement in the vicinity of the or each restricted area includes radio transmitters for transmitting data on detection of tags to said monitoring means, and said monitoring means includes a radio receiver for receiving the data.

5. A tagging system according to claim 1, wherein said at least one second tag detector has a range of at least 150 m.

6. A tagging system according to claim 1, wherein each said tag is active and includes power supply means, a circuit for generating an electromagnetic signal using power from said power supply means, and an antenna for transmitting the electromagnetic signal; and said first and second tag detectors are adapted to receive the transmitted electromagnetic signals from the tags.

7. A tagging system according to claim 6, wherein each said tag is adapted to transmit low frequency radio waves at a level below that at which a licence is required from authorities.

8. A tagging system according to claim 1, wherein each tag is passive and is adapted to respond to an activation signal to transmit said signal; and said first and second tag detectors are adapted to transmit said activation signal and receive said signal from each tag.

9. A tagging system according to claim 8, wherein said at least one first tag detector is adapted to transmit said activation signal only within the region of a respective said entrance, and said at least one second tag detector is adapted to transmit said activation signal over a larger range.

10. A tagging system according to claim 1, wherein said at least one second tag detectors are substantially more sensitive to said signals from said tags than said at least one first tag detectors.

11. A tagging system according to claim 1, wherein each tag includes a smart card in a carrier, said smart card storing monetary value information for purchasing goods and services.

12. A method of tagging persons or objects comprising:
providing each person or object with a tag transmitting a signal carrying an identification code unique to the tag;
detecting identification codes carried by signals from tags passing through one or more entrances to areas using at least one first tag detector which has a detection region limited to the region of the respective entrance;
processing the detected signals to generate an invalid tag signal if a received signal is invalid;
detecting identification codes carried by signals from tags in the areas using at least one second tag detector which has a detection range which is substantially larger than the or each first tag detector; and
identifying respective persons or objects using identification codes detected by said first and second detectors and a database of information on respective persons or objects and said codes for tags being carried by respective persons or objects.

13. A method according to claim 12, wherein at least one of the second tag detectors is mobile and is used for locating and identifying lost or incapacitated persons or objects.

14. A method according to claim 12, wherein at least one of the second tag detectors is arranged in the vicinity of one or more areas restricted for persons or objects and detections of the signals from tags by the or each second tag detector in the vicinity of the or each restricted area is monitored and used to warn of any persons or objects in the vicinity of the or each restricted area.

15. A method according to claim 14, wherein the or each second tag detector arranged in the vicinity of the or each restricted area transmits data on detection of tags to a monitoring station at which the data is received using a radio receiver for performing the monitoring step.

16. A method according to claim 12, wherein the or each second tag detector has a detection range of at least 150 m.

17. A method according to claim 12, wherein each tag is active and actively generates an electromagnetic signal for receipt by said first and second tag detectors.

18. A method according to claim 17, wherein the electromagnetic signal comprises low frequency radio waves at a level below that at which a licence is required from authorities.

19. A method according to claim 12, wherein each tag is passive and responds an activation signal which is transmitted from said first and second tag detectors to transmit said signal.

20. A method according to claim 19, wherein said first tag detector transmits said activation signal only within the region of a respective said entrance and said at least one second tag detector transmits an activation signal over a larger range.

21. A method according to claim 12, wherein the or each second tag detectors are substantially more sensitive to said signal from said tags than the or each first tag detector.

22. A resort management comprising:
tags to be carried by persons in the resort, each tag being adapted to transmit a unique signal to identify the person carrying it and including readable storage means for storing monetary value information;
tag detectors for detecting tags within the vicinity thereof;
information processing means for receiving tag detections to form and store data on the location of persons;
tag issuing means for issuing tags to persons, said tag issuing means being adapted to input information on the persons to said information on the persons to said information processing means; and
storage reading means for reading said storage means of said tags, said storage reading means being adapted to adjust the monetary value information carried by the storage means and to input information on the adjustment of the monetary value information to said information processing means;
wherein said information processing means is adapted to link the data on the location of persons, and the corresponding information on the adjustment of the monetary value information.

23. A resort management system according to claim 22, wherein said tag issuing means comprises at least one automatic vending machine.

24. A resort management system according to claim 22, wherein said readable storage means comprises a smart card carried by said tag.

25. A resort management system according to claim 24, wherein said smart card is removable from said tag.

26. A resort management system according to claim 22, wherein said tags are adapted to transmit a signal carrying an identification code as said unique signal; said tag detectors comprise at least one first tag detector for arrangement at one or more entrances to areas and for detecting the identification code carried by the signals from tags passing through the or each respective entrance, the detection region of said at least one first tag detectors being limited to the region of a respective said entrance, and at least one second tag detector for detecting the identification code carried by the signal from tags in the areas, the detection range of said at least one second tag detector being substantially larger than said at least one first tag detector; and said information processing means includes database means for holding information on respective persons and said codes for tags being carried by respective persons, and for identifying respective persons using identification codes detected by said first and second detectors.

27. A resort management system according to claim 26, wherein said at least one second tag detector includes at least one said second tag detector which is mobile for use for locating lost or incapacitated persons.

28. A resort management system according to claim 26, wherein said at least one second tag detector includes at least one said second tag detector for arrangement in the vicinity of one or more areas restricted for persons; the system including monitoring means for monitoring detections by said at least one second tag detector to warn of any persons in the vicinity of the or each restricted area.

29. A resort management system according to claim 28, wherein each of said at least one second tag detector for arrangement in the vicinity of the or each restricted area includes radio transmitters for transmitting data on detection of tags to said monitoring means, and said monitoring means includes a radio receiver for receiving the data.

30. A resort management system according to claim 26, wherein said at least one second tag detector has a range of at least 150 m.

31. A resort management system according to claim 26, wherein each said tag is active and includes power supply means, a circuit for generating an electromagnetic signal using power from said power supply means, and an antenna for transmitting the electromagnetic signal; and said first and second tag detectors are adapted to receive the transmitted electromagnetic signals from the tags.

32. A resort management system according to claim 31, wherein each said tag is adapted to transmit low frequency radio waves at a level below that at which a licence is required from authorities.

33. A resort management system according to claim 26, wherein each tag is passive and is adapted to respond to an activation signal to transmit said signal; and said first and second tag detectors are adapted to transmit said activation signal and receive said signal from each tag.

34. A resort management system according to claim 33, wherein said at least one first tag detector is adapted to transmit said activation signal only within the region of a respective said entrance, and said at least one second tag detector is adapted to transmit said activation signal over a larger range.

35. A resort management system according to claim 26, wherein said at least one second tag detectors are substantially more sensitive to said signals from said tags than said at least one first tag detectors.

36. A resort management method comprising:
issuing tags to be carried by persons, each tag being adapted to transmit a unique signal to identify the person carrying it and including readable storage means for storing monetary value information;
inputting information on the persons issued with tags to information processing means;
detecting tags in the vicinity of tag detection in the resort;
inputting tag detection information to said information processing means to form and store data on the locations of persons;
reading said storage means of said tags to adjust the monetary value information carried by the storage means;
inputting information on the adjustment of the monetary value information to said information processing means; and
linking the data on the persons, the locations of the persons and the corresponding information on the adjustment of the monetary value information.

37. A resort management method according to claim 36, wherein each said tag transmits a signal carrying an identification code unique to the tag; the step of detecting tags comprises detecting identification codes carried by signals from tags passing through one or more entrances to areas using at least one first tag detector which has a detection region limited to the region of the respective entrance, and detecting identification codes carried by signals from tags in the areas using at least one second tag detector which has a detection range which is substantially larger than the or each first tag detector; and the identifying means identifies respective persons using identification codes detected by said first and second detectors and a database of information on respective persons and said codes for tags being carried by respective persons.

38. A resort management method according to claim 37, wherein at least one of the second tag detectors is mobile and is used for locating and identifying lost or incapacitated persons.

39. A resort management method according to claim 37, wherein at least one of the second tag detectors is arranged in the vicinity of one or more areas restricted for persons and detections of the signals from tags by the or each second tag detector in the vicinity of the or each restricted area is monitored and used to warn of any persons in the vicinity of the or each restricted area.

40. A resort management method according to claim 39, wherein the or each second tag detector arranged in the vicinity of the or each restricted area transmits data on detection of tags to a monitoring station at which the data is received using a radio receiver for performing the monitoring step.

41. A resort management method according to claim 37, wherein the or each second tag detector has a detection range of at least 150 m.

42. A resort management method according to claim 37, wherein each tag is active and actively generates an electromagnetic signal for receipt by said first and second tag detectors.

43. A resort management method according to claim 42, wherein the electromagnetic signal comprises low frequency radio waves at a level below that at which a licence is required from authorities.

44. A resort management method according to claim 37, wherein each tag is passive and responds an activation signal which is transmitted from said first and second tag detectors to transmit said signal.

45. A resort management method according to claim 44, wherein said first tag detector transmits said activation signal only within the region of a respective said entrance and said at least one second tag detector transmits an activation signal over a larger range.

46. A resort management method according to claim 37, wherein the or each second tag detector is substantially more sensitive to said signal from said tags than the or each first tag detector.

47. A tagging system for persons or objects, the tagging system comprising:
tags to be carried by the persons or objects, each tag being adapted to transmit a signal carrying an identification code unique to the tag;
at least one first tag detector for arrangement in the vicinity of one or more areas and for detecting identification codes carried by signals from tags in the vicinity of said areas, the detection region of said at least one first tag detectors being limited to said areas;
processing means for processing the detected signals to determine when persons or objects are in the vicinity of the area;
at least one second tag detector for detecting the identification codes carried by signals from tags away from said areas, the detection range of said at least one second tag detector being substantially larger than said at least one first tag detector; and
database means for holding information on respective persons or objects and said codes for tags being carried by respective persons or objects, and for identifying respective persons or objects using identification codes detected by said first and second detectors.
